(19) United States
(12) Patent Application Publication
(10) Pub. No.: US 2009/0048810 A1
(43) Pub. Date: Feb. 19, 2009

(54) Computer-implemented system and method for assisting in designing resilient member

(75) Inventor: Han-Ting Chen, Hsinchu County (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/071,264

(22) Filed: Feb. 19, 2008

(30) Foreign Application Priority Data
Aug. 15, 2007 (TW) 096130077

(51) Int. Cl. G06F 17/50; G06G 7/48; G06F 17/10

(52) U.S. Cl. 703/1; 703/7; 703/2

(57) ABSTRACT

The invention provides a computer-implemented system for assisting in designing a resilient member. The computer-implemented system includes a storage module, an interface module and a processing module. The storage module therein stores a plurality of response surface functions which each corresponds to one of a plurality of applicable materials. The interface module receives input of a desired one of the plurality of applicable materials and N desired values of N geometrical parameters. The processing module selects, according to the desired material, one from the plurality of response surface functions stored in the storage module, and estimates at least one mechanical property associated with the resilient member by applying the desired values of the geometrical parameters in the selected response surface function.

### BACKGROUND OF THE INVENTION

1. Field of the Invention

The invention relates to a computer-implemented system and method and, more particularly, to a computer-implemented system and method for assisting in designing a resilient member.

2. Description of the Prior Art

Conventionally, a designer can use certain equations associated with material mechanics to estimate mechanical properties according to the geometrical parameters of the materials, and then perform some sample test and/or some experimental measurement according to the estimated results. Doing so costs a lot of time. Besides, accuracy of the equations is acceptable only under some limited conditions such as small deformation, linear elastic zone and sufficient length-width ratio, and if the conditions are beyond limitations, the accuracy will be affected.

The designer can also use a computer aided engineer (CAE) application to perform the estimation. However, in order to master the CAE application, the designer has to posses enough knowledge about engineering material, and spends a lot of time learning how to operate the application. And during estimation, the designer also has to do trial and error iteratively to satisfy actual design requirement.

Accordingly, a scope of the invention is to provide a computer-implemented system and method for assisting in designing a resilient member to solve aforesaid problems.

### SUMMARY OF THE INVENTION

Another scope of the invention is to provide a computer-implemented system and method for assisting in designing a resilient member. The system and method can be used for estimating at least one mechanical property associated with the resilient member by applying the desired values of the geometrical parameters in the response surface function corresponding to the desired material. Thereby, the designer can rapidly and conveniently estimate the mechanical properties associated with the resilient member without being acquainted with material mechanics or CAE-related knowledge. Besides, the actual mechanical properties of the materials based on experimental measurement can be used to update the response surface functions so as to improve the accuracy. Furthermore, in an embodiment of the invention, the system and method can also calculate the estimated values of some geometrical parameters in accordance with the desired values of the other geometrical parameters and the desired mechanical properties on the basis of a numerical optimization, thus greatly improve the efficiency for designing the resilient member.

According to an embodiment of the invention, the computer-implemented system is used for assisting in designing a resilient member. The computer-implemented system includes a storage module, an interface module and a processing module. The storage module therein stores a plurality of response surface functions of mechanical property versus N geometrical parameters, and each of the response surface functions corresponds to one of a plurality of applicable materials. N is a natural number. The interface module is used for receiving input of a desired one of the plurality of applicable materials and N desired values of the N geometrical parameters. The processing module is coupled to the interface module and the storage module, respectively. The processing module is used for selecting, according to the desired material, one from the plurality of response surface functions stored in the storage module, and estimating at least one mechanical property associated with the resilient member by applying the desired values of the geometrical parameters in the selected response surface function.

According to another embodiment of the invention, the computer-implemented method is used for assisting in designing a resilient member. A plurality of response surface functions of mechanical property versus N geometrical parameters are previously provided, and each of the response surface functions corresponds to one of a plurality of applicable materials. N is a natural number. At first, the computer-implemented method receives input of a desired one of the plurality of applicable materials and N desired values of the N geometrical parameters. Then, the method selects one from the plurality of response surface functions according to the desired material. Finally, the method estimates at least one mechanical property associated with the resilient member by applying the desired values of the geometrical parameters in the selected response surface function.

According to another embodiment of the invention, the computer-implemented system is used for assisting in designing a resilient member. The computer-implemented system includes a storage module, an interface module and a processing module. The storage module therein stores a plurality of response surface functions of mechanical property versus N first geometrical parameters and M second geometrical parameters, and each of the response surface functions corresponds to one of a plurality of applicable materials. N and M both are natural numbers. The interface module is used for receiving input of a desired one of the plurality of applicable materials, M desired values of the M second geometrical parameters, a desired mechanical property associated with the resilient member, and a design requirement. The processing module is coupled to the interface module and the storage module, respectively. The processing module is used for selecting, according to the desired material, one from the plurality of response surface functions stored in the storage module, and calculating N estimated values of the N first geometrical parameters in accordance with the M desired values of the M second geometrical parameters and the selected response surface function on the basis of a numerical optimization and the design requirement.

According to another embodiment of the invention, the computer-implemented method is used for assisting in designing a resilient member. A plurality of response surface functions of mechanical property versus N first geometrical parameters and M second geometrical parameters are previously provided, and each of the response surface functions corresponds to one of a plurality of applicable materials. N and M both are natural numbers. At first, the computer-implemented method received input of a desired one of the plurality of applicable materials, M desired values of the M second geometrical parameters, a desired mechanical property associated with the resilient member, and a design requirement. Then, the computer-implemented method selects one from the plurality of response surface functions according to the desired material. Finally, the computer-implemented method calculates N estimated values of the N first geometrical parameters according to the M desired values of the M second geometrical parameters and the selected response surface function based on a numerical optimization and the design requirement.

Therefore, according to the invention, the computer-implemented system and method can be used for assisting in designing a resilient member. The system and method can be used for estimating at least one mechanical property associated with the resilient member by applying the desired values of the geometrical parameters in the response surface function corresponding to the desired material. Thereby, the designer can rapidly and conveniently estimate the mechanical properties associated with the resilient member without being acquainted with material mechanics or CAE-related knowledge. Besides, the actual mechanical properties of the materials based on experimental measurement can be used to update the response surface functions to improve the accuracy. Furthermore, in an embodiment of the invention, the system and method can also calculate the estimated values of some geometrical parameters in accordance with the desired values of the other second geometrical parameters and the desired mechanical properties on the basis of a numerical optimization, thus greatly improve the efficiency for designing the resilient member.

The advantage and spirit of the invention may be understood by the following recitations together with the appended drawings.

### BRIEF DESCRIPTION OF THE APPENDED DRAWINGS

FIG. 1 shows the function block diagram of the computer-implemented system according to an embodiment of the invention.

FIG. 2 shows the content displayed by the displaying module shown in FIG. 1.

FIG. 3 shows the flow chart of the computer-implemented method according to another embodiment of the invention.

FIG. 4 shows the flow chart of the method of updating the response surface function.

FIG. 5 shows the function block diagram of the computer-implemented system according to another embodiment of the invention.

FIG. 6 shows the content displayed by the displaying module shown in FIG. 5.

FIG. 7 shows the flow chart of the computer-implemented method according to another embodiment of the invention.

### DETAILED DESCRIPTION OF THE INVENTION

The invention provides a computer-implemented system and method for assisting in designing a resilient member. The system and method can be used for estimating at least one mechanical property associated with the resilient member by applying the desired values of the geometrical parameters in the response surface function corresponding to the desired material. Thereby, the designer can rapidly and conveniently estimate the mechanical properties associated with the resilient member without being acquainted with material mechanics or CAE-related knowledge. Besides, the actual mechanical properties of the materials based on experimental measurement can be used to update the response surface functions to improve the accuracy. Furthermore, in an embodiment of the invention, the system and method can also calculate the estimated values of some geometrical parameters in accordance with the desired values of the other second geometrical parameters and the desired mechanical properties on the basis of a numerical optimization, thus greatly improve the efficiency for designing the resilient member. The spirit and feature of the present invention will be described in detail by the following embodiments.

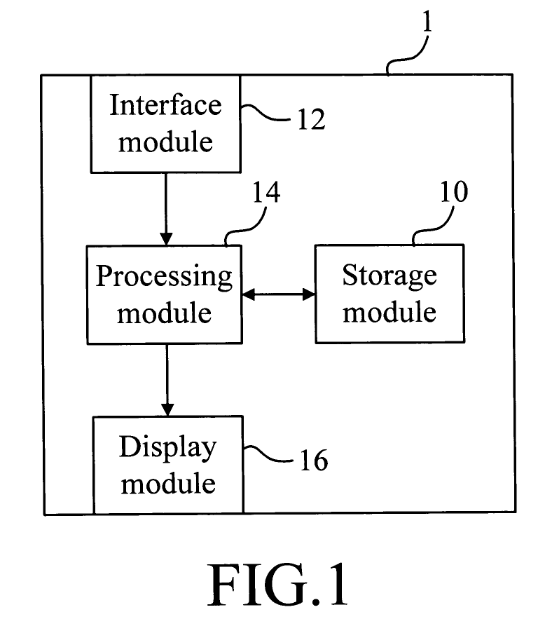

Please refer to FIG. 1. FIG. 1 shows the function block diagram of the computer-implemented system 1 according to an embodiment of the invention. In the embodiment, the computer-implemented system 1 is used for assisting in designing a resilient member. In actual applications, the resilient member is, preferably but not limited to, used for clipping a heat-dissipating device to an electronic device. For example, the resilient member can be a spring beam used for clipping a hear-spreader to a central processing unit.

In the embodiment, the computer-implemented system 1 includes a storage module 10, an interface module 12 and a processing module 14, as shown in FIG. 1. The storage module 10 therein stores a plurality of response surface functions of mechanical property versus N geometrical parameters, and each of the response surface functions corresponds to one of a plurality of applicable materials. N is a natural number. In actual applications, the N geometrical parameters includes, but not limited to, a length, a width, a thickness, or a deflection. In other words, one of the N geometrical parameters can be the length, the width, the thickness, or the deflection associated with the resilient member.

The interface module 12 can be used for receiving input of a desired one of the plurality of applicable materials and N desired values of the N geometrical parameters.

The processing module 14 is coupled to the interface module 12 and the storage module 10, respectively. The processing module 14 can select, according to the desired material, one from the plurality of response surface functions stored in the storage module, and estimates at least one mechanical property associated with the resilient member by applying the desired values of the geometrical parameters in the selected response surface function. In actual applications, the at least one estimated mechanical property can, preferably but not limited to, include an elastic force, a maximum stress or a maximum strain.

In actual applications, the processing module 14 can further compare the estimated mechanical property to a design criterion, and selectively generates an alarm information on the basis of the compared result. For example, one of the at least one estimated mechanical property is a stress, and the design criterion is that the stress can not exceed a first threshold. If the stress calculated by the processing module 14 exceeds the first threshold, the processing module 14 will generate the alarm information for warning the user.

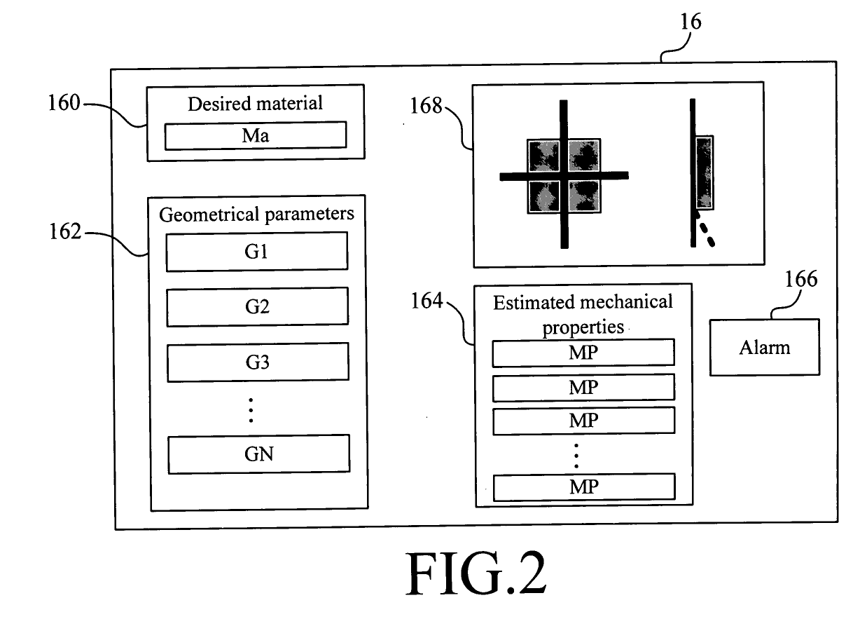

The computer-implemented system 1 can further include a displaying module 16 coupled to the processing module 14. Please refer to FIG. 2. FIG. 2 shows the content displayed by the displaying module 16 shown in FIG. 1. In actual applications, the displaying module 16 can display the desired material Ma in a first display region 160, the desired values G1-GN of the geometrical parameters in a second display region 162, the at least one estimated mechanical property MP in a third display region 164, and the alarm information Alarm in a fourth display region 166. Besides, the displaying module 16 can also display the resilient member and the heat-dissipating device in a fifth display region 168 for user reference.

In actual applications, the interface module 12 can further receive input of at least one actual mechanical property corresponding to the desired material and the desired values of the geometrical parameters. For instance, the actual mechanical property is obtained from sample experiment or product test. The processing module 14 can further generate, according to the at least one actual mechanical property, the desired values of the geometrical parameters and data regarding the selected response surface function stored in the storage module, an updated response surface function, and replaces the selected response surface function stored in the storage module by the updated response surface function. Thereby the estimation accuracy the computer-implemented system 1 can be improved.

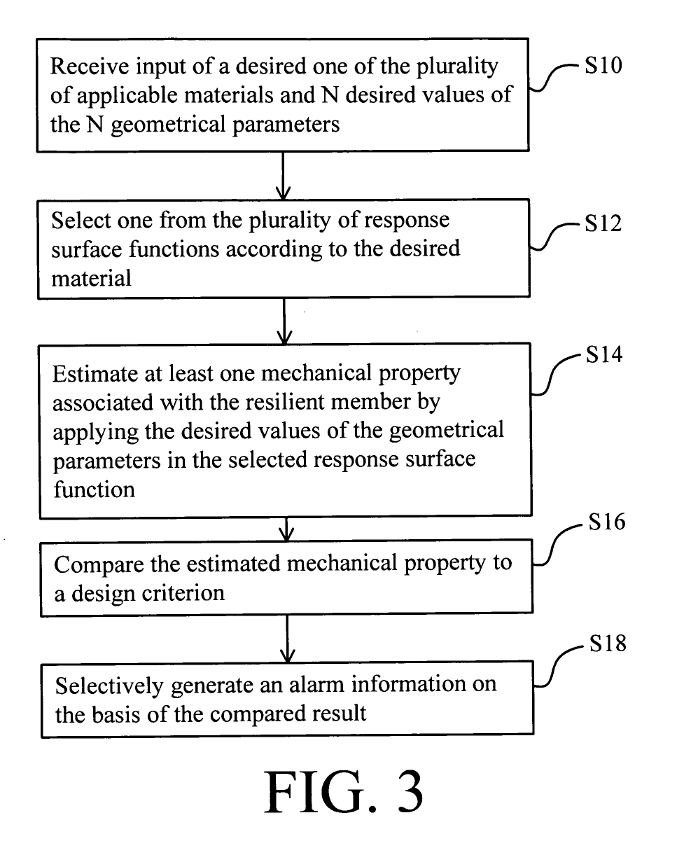

Please refer to FIG. 3. FIG. 3 shows the flow chart of the computer-implemented method according to another embodiment of the invention. The computer-implemented method is used for assisting in designing a resilient member. In actual applications, the resilient member is, preferably but not limited to, used for clipping a heat-dissipating device to an electronic device. For example, the resilient member can be a spring beam used for clipping a hear-spreader to a central processing unit.

In the embodiment, a plurality of response surface functions of mechanical property versus N geometrical parameters are previously provided, and each of the response surface functions corresponds to one of a plurality of applicable materials. N is a natural number. In actual applications, the N geometrical parameters includes, but not limited to, a length, a width, a thickness, or a deflection. In other words, one of the N geometrical parameters can be the length, the width, the thickness, or the deflection associated with the resilient member.

As shown in FIG. 3, the computer-implemented method, firstly, performs step S10 to receive input of a desired one of the plurality of applicable materials and N desired values of the N geometrical parameters. Then, the computer-implemented method performs step S12 to select one from the plurality of response surface functions according to the desired material. Afterwards, the computer-implemented method performs step S14 to estimate at least one mechanical property associated with the resilient member by applying the desired values of the geometrical parameters in the selected response surface function. In actual applications, the at least one estimated mechanical property can, preferably but not limited to, include an elastic force, a maximum stress or a maximum strain. After that, the computer-implemented method performs step S16 to compare the estimated mechanical property to a design criterion. Finally, the computer-implemented method performs step S18 to selectively generate an alarm information on the basis of the compared result. For example, one of the at least one estimated mechanical property is a stress, and the design criterion is that the stress can not exceed a first threshold. If the compared result in step S16 is that the stress exceeds the first threshold, the alarm information will be generated in step S18 for warning the user.

In actual applications, the computer-implemented method can further include the step of displaying the desired material, the desired values of the geometrical parameters, the at least one estimated mechanical property, and the alarm information.

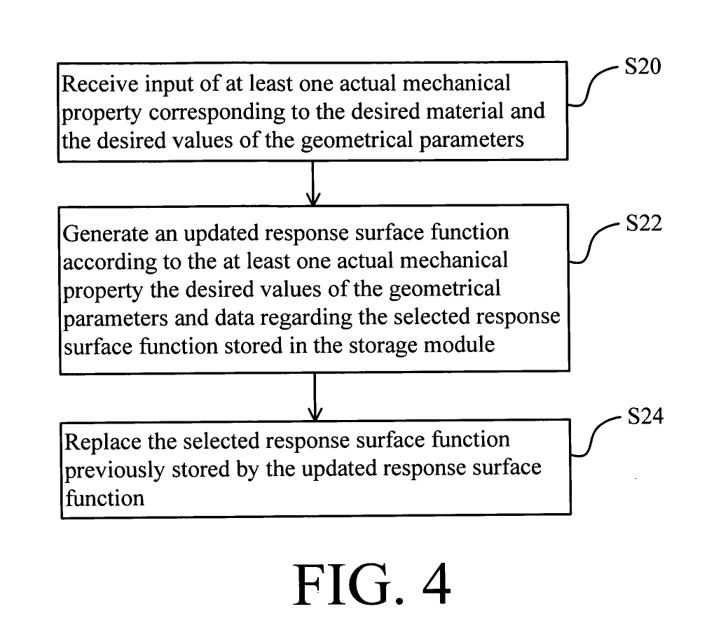

Please refer to FIG. 4. FIG. 4 shows the flow chart of the method of updating the response surface function. In actual applications, in order to improve the accuracy, the computer-implemented method can further include following steps. As shown in FIG. 4, the computer-implemented method, firstly, performs step S20 to receive input of at least one actual mechanical property corresponding to the desired material and the desired values of the geometrical parameters. Then, the computer-implemented method performs step S22 to generate an updated response surface function according to the at least one actual mechanical property the desired values of the geometrical parameters and data regarding the selected response surface function. Finally, the computer-implemented method performs step S24 to replace the selected response surface function by the updated response surface function.

Thereby, the designer of the resilient member can rapidly and conveniently estimate the mechanical properties associated with the resilient member without being acquainted with material mechanics or CAE-related knowledge.

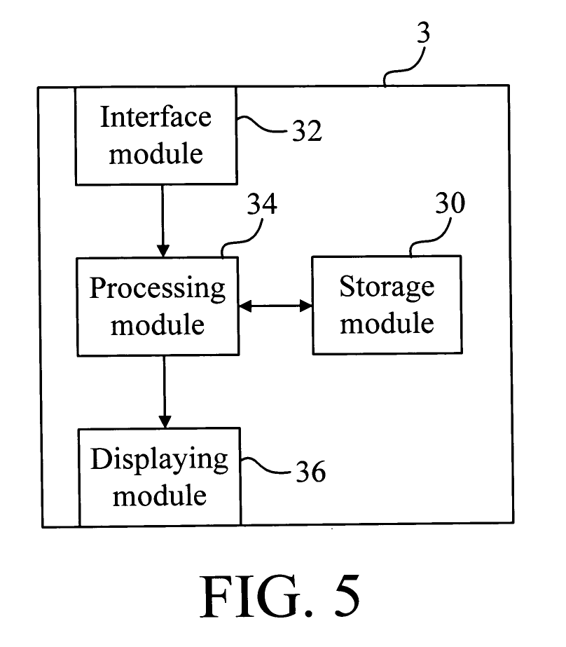

Please refer to FIG. 5. FIG. 5 shows the function block diagram of the computer-implemented system 3 according to another embodiment of the invention. In actual applications, the resilient member is, preferably but not limited to, used for clipping a heat-dissipating device to an electronic device. For example, the resilient member can be a spring beam used for clipping a hear-spreader to a central processing unit.

In the embodiment, the computer-implemented system 3 includes a storage module 30, an interface module 32 and a processing module 34, as shown in FIG. 5. The storage module 30 therein stores a plurality of response surface functions of mechanical property versus N first geometrical parameters and M second geometrical parameters, and each of the response surface functions corresponds to one of a plurality of applicable materials. N and M both are natural numbers. The N first geometrical parameters are the estimated values calculated by the processing module 34 and the M second geometrical parameters are the desired values inputted by a user. In actual applications, the N first geometrical parameters and the M second geometrical parameters include, but not limited to, a length, a width, a thickness, or a deflection. In other words, one of the N first geometrical parameters and the M second geometrical parameters can be the length, the width, the thickness, or the deflection associated with the resilient member.

The interface module 32 can be used for receiving input of a desired one of the plurality of applicable materials, M desired values of the M second geometrical parameters, a desired mechanical property associated with the resilient member, and a design requirement. In actual applications, the desired mechanical property can be, but not limited to, an elastic force, a maximum stress and a maximum strain. In practice, the design requirement can be, but not limited to, that the volume of the resilient member is minimal.

The processing module 34 is coupled to the interface module 32 and the storage module 30, respectively. The processing module 34 can select, according to the desired material, one from the plurality of response surface functions stored in the storage module, and calculates N estimated values of the N first geometrical parameters in accordance with the M desired values of the M second geometrical parameters and the selected response surface function on the basis of a numerical optimization and the design requirement. In actual applications, the numerical optimization can be, preferably but not limited to, a sequential quadratic programming optimization.

In other words, the user only has to provide the desired material, the desired mechanical property, the design requirement (e.g. the volume of the resilient member is minimal), and the M desired values of the M second geometrical parameters (e.g. length and width), and the processing module 34 can accordingly calculate the N estimated values of the N first geometrical parameters.

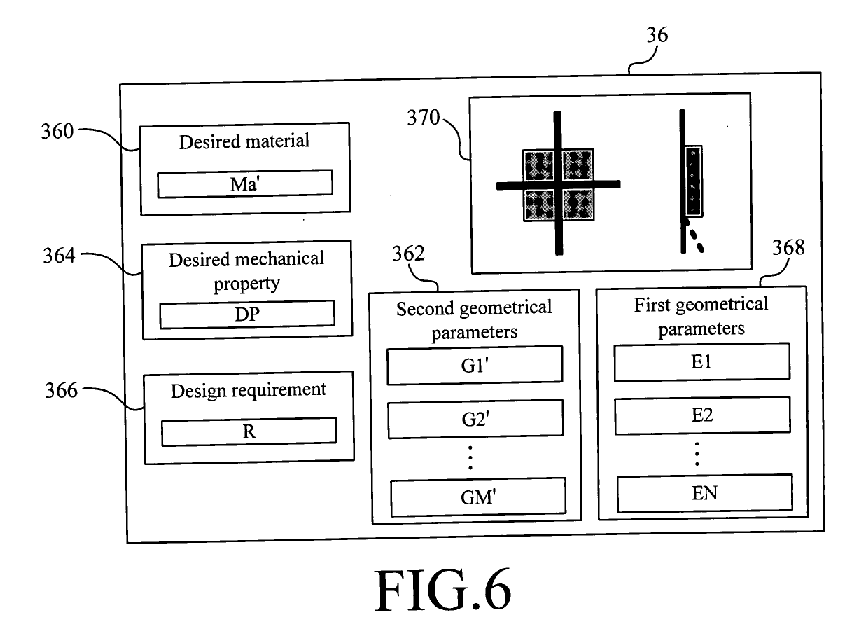

The computer-implemented system 3 can further include a displaying module 36 coupled to the processing module 34. Please refer to FIG. 6. FIG. 6 shows the content displayed by the displaying module 36 shown in FIG. 6. In actual applications, the displaying module 36 can display the desired material Ma′ in a sixth display region 360, the M desired values G1′-GM′ of the M second geometrical parameters in a seventh display region 362, the desired mechanical property DP in an eighth display region 364, the design requirement R in a ninth display region 366, and the N estimated values E1-En of the N first geometrical parameters in a tenth display region 368. Besides, the displaying module 36 can also display the resilient member and the heat-dissipating device in an eleventh display region 370 for user reference.

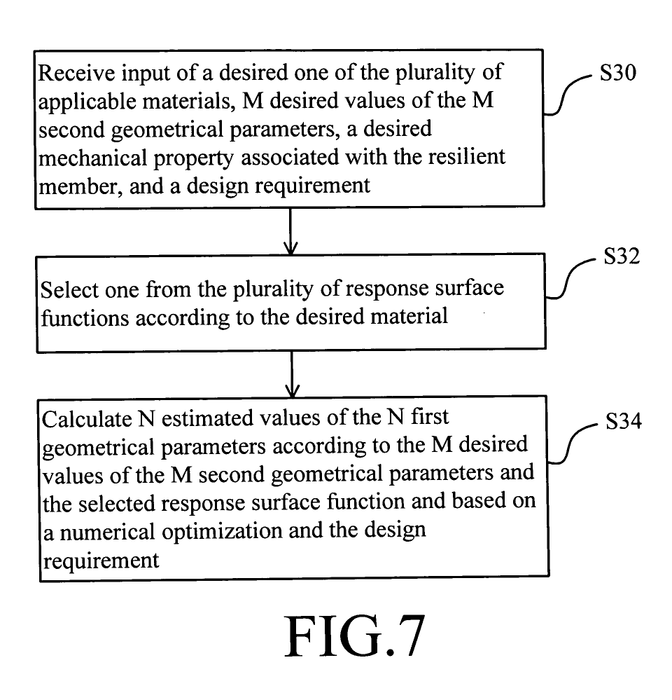

Please refer to FIG. 7. FIG. 7 shows the flow chart of the computer-implemented method according to another embodiment of the invention. In actual applications, the resilient member is, preferably but not limited to, used for clipping a heat-dissipating device to an electronic device. For example, the resilient member can be a spring beam used for clipping a hear-spreader to a central processing unit.

In the embodiment, a plurality of response surface functions of mechanical property versus N first geometrical parameters and M second geometrical parameters are previously provided, and each of the response surface functions corresponds to one of a plurality of applicable materials. N and M both are natural numbers. In actual applications, the N first geometrical parameters and the M second geometrical parameters include, but not limited to, a length, a width, a thickness, or a deflection. In other words, one of the N first geometrical parameters and the M second geometrical parameters can be the length, the width, the thickness, or the deflection associated with the resilient member.

As shown in FIG. 7, the computer-implemented method, firstly, performs step S30 to receive input of a desired one of the plurality of applicable materials, M desired values of the M second geometrical parameters, a desired mechanical property associated with the resilient member, and a design requirement. In actual applications, the desired mechanical property can be, but not limited to, an elastic force, a maximum stress and a maximum strain. In practice, the design requirement can be, but not limited to, that the volume of the resilient member is minimal.

Then, the computer-implemented method performs step S32 to select one from the plurality of response surface functions according to the desired material. Finally, the computer-implemented method performs step S34 to calculate N estimated values of the N first geometrical parameters according to the M desired values of the M second geometrical parameters and the selected response surface function based on a numerical optimization and the design requirement. In actual applications, the numerical optimization can be, preferably but not limited to, a sequential quadratic programming optimization. In other words, the user only has to provide the desired material, the desired mechanical property, the design requirement (e.g. the volume of the resilient member is minimal), and the M desired values of the M second geometrical parameters (e.g. length and width), and the N estimated values of the N first geometrical parameters can be can accordingly calculated in step S34.

In actual applications, the computer-implemented method can further include the step of displaying the desired material, the M desired values of the M second geometrical parameters, the desired mechanical property, the design requirement, and the N estimated values of the N first geometrical parameters.

Comparing with prior art, the computer-implemented system and method can be used for assisting in designing a resilient member. The system and method can be used for estimating at least one mechanical property associated with the resilient member by applying the desired values of the geometrical parameters in the response surface function corresponding to the desired material. Thereby, the designer can rapidly and conveniently estimate the mechanical properties associated with the resilient member without being acquainted with material mechanics or CAE-related knowledge. Besides, the actual mechanical properties of the materials based on experimental measurement can be used to update the response surface functions so as to improve the accuracy. Furthermore, in an embodiment of the invention, the system and method can also calculate the estimated values of some geometrical parameters in accordance with the desired values of the other second geometrical parameters and the desired mechanical properties on the basis of a numerical optimization, thus greatly improve the efficiency for designing the resilient member.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A computer-implemented system for assisting in designing a resilient member, said computer-implemented system comprising:
a storage module therein storing a plurality of response surface functions of mechanical property versus N geometrical parameters, each of the response surface functions corresponding to one of a plurality of applicable materials, N being a natural number;
an interface module for receiving input of a desired one of the plurality of applicable materials and N desired values of the N geometrical parameters; and
a processing module, coupled to the interface module and the storage module, respectively, for selecting, according to the desired material, one from the plurality of response surface functions stored in the storage module, and estimating at least one mechanical property associated with the resilient member by applying the desired values of the geometrical parameters in the selected response surface function.

2. The computer-implemented system of claim 1, wherein the N geometrical parameters comprise one selected from the group consisting of a length, a width, a thickness, and a deflection.

3. The computer-implemented system of claim 1, wherein the at least one estimated mechanical property comprises one selected from the group consisting of an elastic force, a maximum stress and a maximum strain.

4. The computer-implemented system of claim 1, wherein the processing module further compares the estimated mechanical property to a design criterion, and selectively generates an alarm information on the basis of the compared result.

5. The computer-implemented system of claim 4, further comprising a displaying module, coupled to the processing module, for displaying the desired material, the desired values of the geometrical parameters, the at least one estimated mechanical property, and the alarm information.

6. The computer-implemented system of claim 1, wherein the interface module further receives input of at least one actual mechanical property corresponding to the desired material and the desired values of the geometrical parameters, the processing module further generates, according to the at least one actual mechanical property, the desired values of the geometrical parameters and data regarding the selected response surface function stored in the storage module, an updated response surface function, and replaces the selected response surface function stored in the storage module by the updated response surface function.

7. A computer-implemented method for assisting in designing a resilient member, a plurality of response surface functions of mechanical property versus N geometrical parameters being previously provided, each of the response surface functions corresponding to one of a plurality of applicable materials, N being a natural number, said computer-implemented method comprising the steps of:
receiving input of a desired one of the plurality of applicable materials and N desired values of the N geometrical parameters;
according to the desired material, selecting one from the plurality of response surface functions; and
estimating at least one mechanical property associated with the resilient member by applying the desired values of the geometrical parameters in the selected response surface function.

8. The computer-implemented method of claim 7, wherein the N geometrical parameters comprise one selected from the group consisting of a length, a width, a thickness, and a deflection.

9. The computer-implemented method of claim 7, wherein the at least one estimated mechanical property comprises one selected from the group consisting of an elastic force, a maximum stress and a maximum strain.

10. The computer-implemented method of claim 7, further comprising the steps of:
comparing the estimated mechanical property to a design criterion; and
selectively generating an alarm information on the basis of the compared result.

11. The computer-implemented method of claim 10, further comprising the step of displaying the desired material, the desired values of the geometrical parameters, the at least one estimated mechanical property, and the alarm information.

12. The computer-implemented method of claim 7, further comprising the steps of:
receiving input of at least one actual mechanical property corresponding to the desired material and the desired values of the geometrical parameters;
according to the at least one actual mechanical property the desired values of the geometrical parameters and data regarding the selected response surface function, generating an updated response surface function; and
replacing the selected response surface function by the updated response surface function.

13. A computer-implemented system for assisting in designing a resilient member, said computer-implemented system comprising:
a storage module therein storing a plurality of response surface functions of mechanical property versus N first geometrical parameters and M second geometrical parameters, each of the response surface functions corresponding to one of a plurality of applicable materials, N and M both being natural numbers;
an interface module for receiving input of a desired one of the plurality of applicable materials, M desired values of the M second geometrical parameters, a desired mechanical property associated with the resilient member, and a design requirement; and
a processing module, coupled to the interface module and the storage module, respectively, for selecting, according to the desired material, one from the plurality of response surface functions stored in the storage module, and calculating N estimated values of the N first geometrical parameters in accordance with the M desired values of the M second geometrical parameters and the selected response surface function on the basis of a numerical optimization and the design requirement.

14. The computer-implemented system of claim 13, wherein the N first geometrical parameters and the M second geometrical parameters comprise one selected from the group consisting of a length, a width, a thickness, and a deflection.

15. The computer-implemented system of claim 13, wherein the desired mechanical property is one selected from the group consisting of an elastic force, a maximum stress and a maximum strain.

16. The computer-implemented system of claim 13, further comprising a displaying module, coupled to the processing module, for displaying the desired material, the M desired values of the M second geometrical parameters, the desired mechanical property, the design requirement, and the N estimated values of the N first geometrical parameters.

17. A computer-implemented method for assisting in designing a resilient member, a plurality of response surface functions of mechanical property versus N first geometrical parameters and M second geometrical parameters being previously provided, each of the response surface functions corresponding to one of a plurality of applicable materials, N and M being natural numbers, said computer-implemented method comprising the steps of:
receiving input of a desired one of the plurality of applicable materials, M desired values of the M second geometrical parameters, a desired mechanical property associated with the resilient member, and a design requirement;
according to the desired material, selecting one from the plurality of response surface functions; and
according to the M desired values of the M second geometrical parameters and the selected response surface function based on a numerical optimization and the design requirement, calculating N estimated values of the N first geometrical parameters.

18. The computer-implemented method of claim 17, wherein the N first geometrical parameters and the M second geometrical parameters comprise one selected from the group consisting of a length, a width, a thickness, and a deflection.

19. The computer-implemented method of claim 17, wherein the desired mechanical property is one selected from the group consisting of an elastic force, a maximum stress and a maximum strain.

20. The computer-implemented method of claim 17, further comprising the step of displaying the desired material, the M desired values of the M second geometrical parameters, the desired mechanical property, the design requirement, and the N estimated values of the N first geometrical parameters.
